(19) United States
(12) Patent Application Publication
(10) Pub. No.: US 2012/0317488 A1
(43) Pub. Date: Dec. 13, 2012

(54) TECHNIQUES FOR ADAPTING AN INTERPRETIVE RUN TIME APPLICATION TO MULTIPLE CLIENTS

(75) Inventors: Christopher Rudolph, West Fargo, ND (US); Michael Hammond, Moorhead, MN (US); Robert Anderson, Fargo, ND (US); Erik Nissen, Hawley, MN (US); John Nannenga, Fargo, ND (US); Andrew Ingalls, Fargo, ND (US)

(73) Assignee: MICROSOFT CORPORATION, Redmond, WA (US)

(21) Appl. No.: 13/159,139

(22) Filed: Jun. 13, 2011

(51) Int. Cl. G06F 3/048; G06F 15/16

(52) U.S. Cl. 715/733

(57) ABSTRACT

Techniques to adapt an interpretive runtime engine to multiple clients are described. An apparatus may comprise a logic device arranged to execute a web client. The web client may comprise, among other elements, a client adapter operative to detect a user event for a client user interface, send changes to user event properties associated with the user event to a server application, receive a graphical user interface (GUI) independent object and updated user event properties from the server application, and update a rendered image in the client user interface using the GUI independent object and updated user event properties received from the server application. Other embodiments are described and claimed.

### RELATED APPLICATION

The instant application is related to commonly owned U.S. Pat. No. ______ titled “Automated User Interface Object Transformation And Code Generation” filed on ______ (Client Docket Number 332381.01), the entirety of which is hereby incorporated by reference.

### BACKGROUND

A client-server architecture is a distributed application structure that partitions computing tasks or workloads for an application program between two basic entities, referred to as servers and clients. A server is a provider of resources or services. A client is a requester of resources or services. A server is a physical or logical device that is running one or more server programs which share their resources with clients. A client is a physical or logical device that typically does not share any of its resources, but requests content or service functions from a server. Clients and servers often communicate over a computer network on separate hardware. However, in some cases both client and server may reside in the same system. Clients therefore initiate communication sessions with servers which await incoming requests.

One form of client-server architecture is a multi-tier architecture, often referred to as n-tier architecture. A n-tier architecture is a client-server architecture in which certain aspects of an application program are separated into multiple tiers. For example, an application that uses middleware to service data requests between a user and a database employs a multi-tier architecture. An n-tier application architecture provides a model for developers to create a flexible and reusable application. By breaking up an application into multiple tiers, developers only have to modify or add a specific tier (or layer), thereby avoiding the need to rewrite an entire application.

A n-tier architecture provides many advantages when developing and modifying an application program. However, there are difficulties in implementing a n-tier architecture for a web-based environment where there are a large number of clients. Each client may utilize different web technologies, including different web browsers, web services, and web applications. Further, web technologies are designed to work with many different types of underlying hardware and software architectures, including a variety of devices having different input/output (I/O) components, form factors, power requirements, processing capabilities, communication capabilities, memory resources, and so forth. As such, it may be difficult to implement one or more tiers across these many heterogeneous devices and architectures. Furthermore, web versions of an application program may not be compatible with non-web versions of an application program, thereby creating a need for separate software architectures for each. It is with respect to these and other disadvantages that the present improvements are needed.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Various embodiments are generally directed to a client-server architecture suitable for executing different types of application programs, such as commercial line-of-business application programs, for example. Some embodiments are particularly directed to a n-tier client-server architecture having multiple tiers (or layers) of an application program, including at least one presentation tier. In one embodiment, for example, a 3-tier client-server architecture may include a presentation tier implemented using techniques designed to separate and enhance graphical user interface (GUI) rendering of user events when adapting an interpretive runtime engine application to operate with many different types of clients.

In one embodiment, for example, an apparatus may comprise a logic device arranged to execute a web client. The web client may comprise, among other elements, a client adapter operative to detect a user event for a client user interface, send changed user event properties associated with the user event to a server application, receive a graphical user interface (GUI) independent object and updated user event properties from the server application, and update a rendered image in the client user interface using the GUI independent object and updated user event properties received from the server application. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1A illustrates a conventional desktop application architecture.

FIG. 1B illustrates a conventional 2-tier application architecture.

FIG. 1C illustrates a conventional 3-tier application architecture.

FIG. 2 illustrates a block diagram of an enhanced n-tier client-server architecture having multiple clients and client adapters in accordance with one embodiment.

FIG. 3 illustrates a block diagram of an enhanced n-tier client-server architecture having a single client and client adapter in accordance with one embodiment.

FIG. 4 illustrates a block diagram of an enhanced n-tier client-server architecture having a graphical user interface (GUI) independent object for a client and client adapter in accordance with one embodiment.

FIG. 5 illustrates a first logic flow of an enhanced n-tier client-server architecture in accordance with one embodiment.

FIG. 6A illustrates a logic diagram of a GUI independent object in accordance with one embodiment.

FIG. 6B illustrates a logic diagram of a specific GUI independent object in accordance with one embodiment.

FIG. 7 illustrates a second logic flow of an enhanced n-tier client-server architecture in accordance with one embodiment.

FIG. 8 illustrates an embodiment of a computing architecture suitable for an enhanced n-tier client-server architecture in accordance with one embodiment.

FIG. 9 illustrates an embodiment of a communications architecture suitable for an enhanced n-tier client-server architecture in accordance with one embodiment.

### DETAILED DESCRIPTION

Various embodiments are generally directed to a client-server architecture suitable for executing different types of commercial line-of-business application programs. Some embodiments are particularly directed to an enhanced n-tier client-server architecture, where n is a variable representing any positive integer. The enhanced n-tier architecture may comprise multiple tiers (or layers) of an application program, including at least one presentation tier. In one embodiment, for example, the enhanced n-tier architecture may be implemented as a 3-tier architecture comprising a presentation tier, an application processing tier, and a data management tier. The presentation tier generally implements user interface logic, such as handling input/output operations. The application processing tier generally implements application or business logic, such as processing data according to a set of application rules. The data management tier generally implements data storage and access, such as defining data schemas, storing data, processing data queries, and so forth.

The enhanced n-tier client-server architecture may include a presentation tier implemented using techniques designed to facilitate the separation and optimization of GUI rendering and user events in an application using an interpretive runtime engine. It allows adapting an interpretive runtime engine application from a 2-tier client-server based architecture to a hosted 3-tier environment while reducing changes to the interpretive runtime engine application.

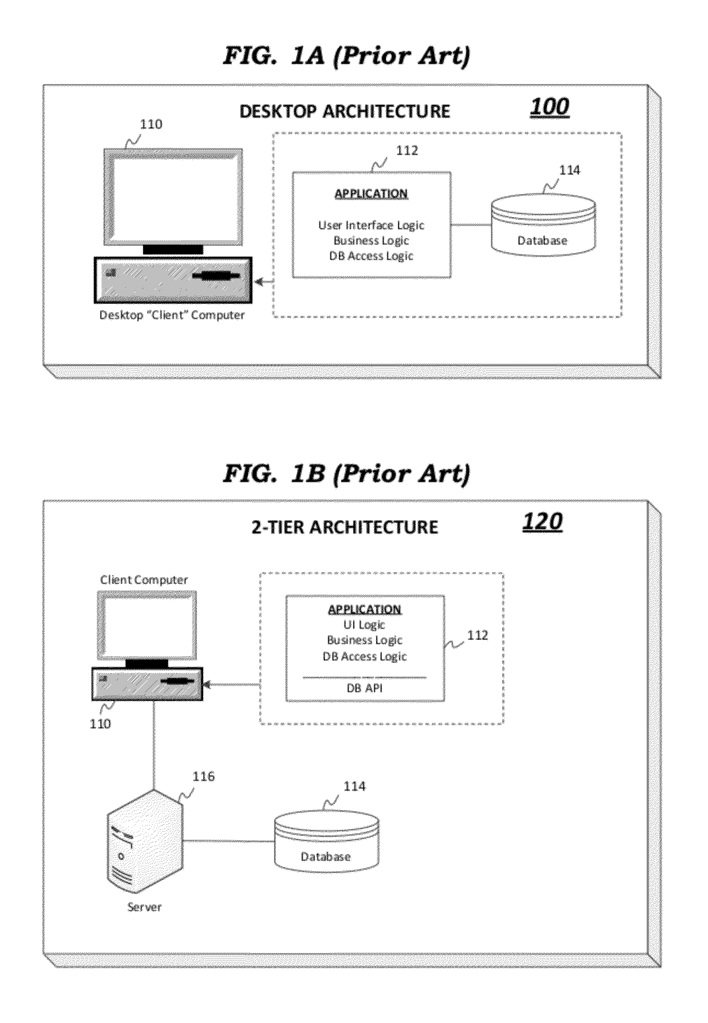

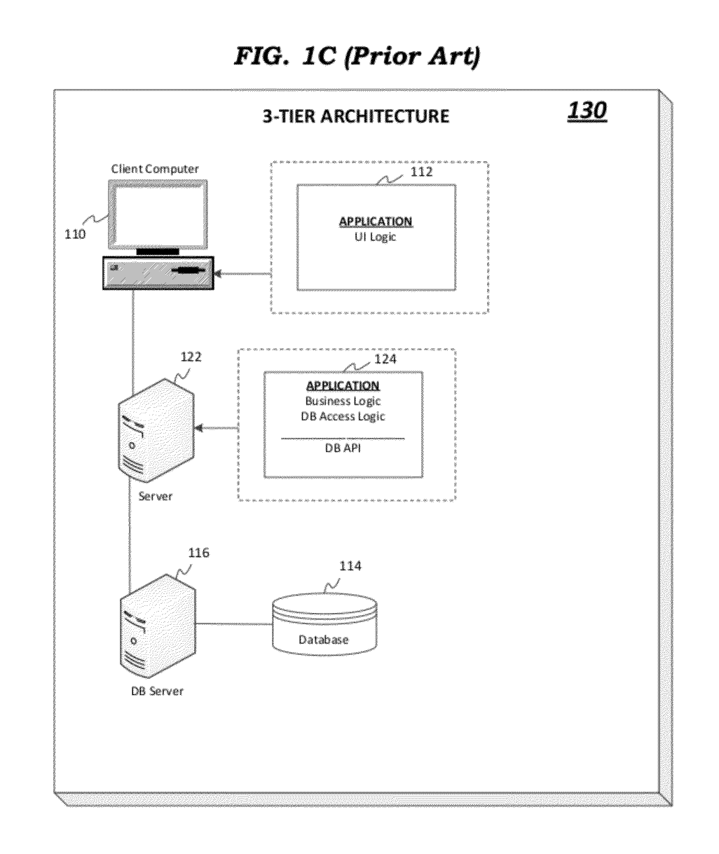

FIGS. 1A, 1B and 1C illustrate three conventional architectures for application development by way of background to highlight advantages for various embodiments of the enhanced n-tier client-server architecture. FIG. 1A illustrates a conventional desktop architecture. FIG. 1B illustrates a conventional 2-tier architecture. FIG. 1C illustrates a conventional 3-tier (or n-tier) architecture.

FIG. 1A is an example of a desktop architecture 100 in which all parts (or application layers) of an application program 112 are implemented on a client computer 110 (e.g., a desktop computer). The application program 112 may comprise various application layers implementing, for example, user interface (UI) logic, business logic, and database access logic. The application program 112 may store and access application data from a database 114, which is also implemented on the client computer 110.

FIG. 1B is an example of a 2-tier architecture 120 in which a database 114 is now remote from the client computer 10. In the 2-tier architecture 120, the application program 112 and its constituent application layers still exist on the client computer 10. However, the database 114 has been moved from the client computer 110 to a database server 116. The application program 112 running in the client computer 10 sends requests for data via database application program interfaces (APIs) to the database server 16 that is communicatively coupled with the database 114. The requested data is then returned to the application program 112 executing on the client computer 10.

FIG. 1C is an example of a 3-tier architecture 130. In the 3-tier architecture 130, the application program 112 may be separated into distributed application programs 112, 124 executing on respective client computer 110 and a server 122. The application program 112 may implement an application layer having UI logic. The application program 124 may implement an application layer having business and database access logic. The application program 112 running in the client computer 110 sends data to the server 122 that is executing the application program 124. The application program 124 may then execute business logic and send requests for data to the database server 116 that is communicatively coupled with database 18. The requested data and the results of the executed business logic are then returned to the application program 112 and rendered in the client computer 110. It should be noted that the database server 116 may be co-located with the server 122 or be a part of the server 122. In other words, the hardware architecture may be such that a single server 122 functions as both an application and database server. A distinguishing factor between a 2-tier and a 3-tier (or n-tier) architecture is that some or many of the application layers are moved out of the client computer 110 and distributed among one or more other servers 116, 122.

A n-tier architecture, such as the 3-tier architecture 130, may provide many advantages relative to a 2-tier architecture 120 when developing and modifying an application program. For instance, a single tier may be modified or added without causing a complete re-write of the entire application program. However, there are difficulties in implementing a n-tier architecture for a web-based environment where there are a large number of clients. Each client may utilize different web technologies, including different web browsers, web services, and web applications. Further, web technologies are designed to work with many different types of underlying hardware and software architectures, including a variety of devices having different input/output (I/O) components, form factors, power requirements, processing capabilities, communication capabilities, memory resources, and so forth. As such, it may be difficult to implement a given application layer, such as a presentation layer, uniformly across these many heterogeneous devices and architectures without extensive customization of the presentation layer to fit the unique configuration of each client. Furthermore, web versions of an application program may not be compatible with non-web versions of an application program, thereby creating a need for separate software architectures for each.

In various embodiments, an enhanced n-tier architecture provides a framework that enables migration of a 2-tier client-server application architecture to a 3-tier application architecture that utilizes a thin client for a presentation layer of an application program. In one embodiment, for example, each client device may implement a thin client in the form of a web client. A web client typically refers to a thin client application implemented using web technologies, such as a web browser operating in a client computer, for example. It may also refer to plug-ins and helper applications that enhance the browser to support custom services from the site or server. Any references herein to a web client may also refer to the functionality of a web browser.

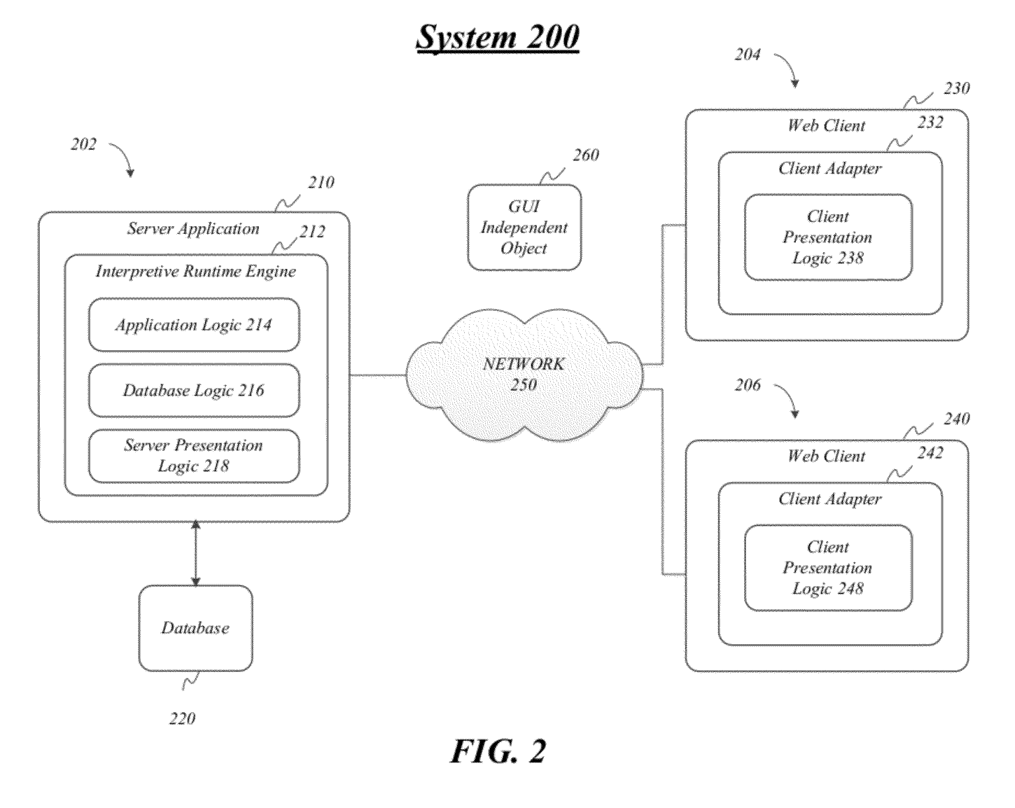

FIG. 2 illustrates a client-server system 200. In one embodiment, the client-server system 200 may comprise an enhanced n-tier client-server system. The enhanced n-tier client-server system may separate an application program in multiple tiers, including a presentation tier. The presentation tier may be implemented using techniques designed to facilitate the separation and optimization of GUI rendering and user events in the application program using an interpretive runtime engine. It allows adapting an interpretive runtime engine application from a 2-tier client-server based architecture to a hosted 3-tier environment while reducing changes needed for the interpretive runtime engine application.

As previously described with reference to FIG. 1A, many applications follow a 2-tier application architecture in which the application is organized into two interrelated components—the database server and the client application. The database server may host system and company data, along with extended business logic that allows it to process some of the heavier operations that would be extremely time consuming to perform at the client. Meanwhile, the client application may perform the functions of delivering the UI, providing data entry validation, and rendering reports, among other functions.

In the illustrated embodiment shown in FIG. 2, the client-server system 200 may comprise a server 202 and multiple clients 204, 206. When implemented on different hardware platforms, the server 202 and the clients 204, 206 may communicate with each other via a network 250. When implemented on a same hardware platform, the server 202 and the clients 204, 206 may communicate with each other via suitable bus technologies and architectures. Although FIG. 2 illustrates only a single server 202 and two clients 204, 206 for sake of clarity, it may be appreciated that the client-server system 200 may implement any number of servers and clients as desired for a given implementation. The embodiments are not limited in this context.

In one embodiment, the server 202 may comprise an electronic device implementing a server application 210. The server application 210 may comprise any type of server application, such as a commercial line-of-business application. Examples of commercial line-of-business applications may include without limitation an accounting program, an enterprise resource planning (ERP) application, a customer relationship management (CRM) application, a supply chain management (SCM) application, and so forth. These commercial line-of-business applications are sometimes referred to as “middle-tier” applications as they are typically executed by servers or server arrays in commercial enterprise networks, rather than client devices such as a desktop computer. A specific example may include Microsoft® Dynamics GP, made by Microsoft Corporation, Redmond, Wash. Microsoft Dynamics GP is a commercial accounting software application. Another specific example of a commercial line-of-business application may comprise a Microsoft Dynamics® AX made by Microsoft Corporation, Redmond, Wash. Microsoft Dynamics AX is a commercial ERP software application. However, the embodiments are not limited to these examples.

When the server 202 is executing code for the server application 210, the server 202 forms an interpretive runtime engine 212. The interpretive runtime engine 212 implements multiple application layers for the server application 210, referred to in the client-server system 200 as application logic 214, database logic 216, and server presentation logic 218. The server application 210 may be controlled and operated via control directives received from the clients 204, 206 in the form of signals or messages over the network 250.

In one embodiment, the clients 204, 206 may each comprise an electronic device implementing respective web clients 230, 240. The web clients 230, 240 may each comprise, for example, instances of a web browser executing on the respective clients 204, 206. The web browsers may also include plug-ins, web applications and helper applications designed to enhance the web browsers to support custom services from the server 202. Any references herein to web clients 230, 240 may also refer to functionality of a web browser.

The clients 204, 206 may comprise respective client adapters 232, 242. Each of the client adapters 232, 242 may be configured for use with a given client 204, 206. In this manner, the server application 210 and the interpretive runtime engine 212 do not need to be modified when accessed by different clients using different web technologies.

The client adapters 232, 242 may comprise respective client presentation logic 238, 248. The client presentation logic 238, 248 may be designed to present user interface elements or views on an output device for the clients 204, 206, such as a digital display, for example. The client presentation logic 238, 248 may be designed to interoperate with the application logic 214, the database logic 216, and the server presentation logic 218 of the server application 210 executing on the server 202, in accordance with the distributed n-tier architecture implemented for the server application 210.

The client adapters 232, 242, and respective client presentation logic 238, 248, may interoperate with the server presentation logic 218 to allow the server application 210 to be accessed via different clients 204, 206. Each client 204, 206 may implement different versions of the server presentation logic 218 as the respective client presentation logic 238, 248 to fit a particular configuration for the clients 204, 206. This may be accomplished without having to re-write the server presentation logic 218, and more importantly, the business logic 214 and the database logic 216. Further, the server presentation logic 218 and the client presentation logic 238, 248 may interact in a manner that reduces communication traffic and overhead for the network 250, thereby increasing speed and performance while reducing latency associated with communication delays.

The server application 210 may communicate with the client adapters 232, 242, or separate versions of each, separately or simultaneously. A scenario for simultaneous operation may include when a user requires assistance, and an administrator desires to view a second version of a user's web client view.

In various embodiments, the server presentation logic 218 and the client presentation logic 238, 248 may interact in an efficient manner utilizing a graphical user interface (GUI) independent object 260. The GUI independent object 260 allows for GUI elements, such as GUI screens (e.g., Microsoft Windows® Forms), to move freely between desktop environments and web environments. The GUI independent object 260 allows the server application 210 to run as a service in the background, awaiting user events that may be received either via a traditional OS form or a web client form, and still be able to execute script events regardless of the type of form through which it was submitted.

The GUI independent object 260 may contain, among other types of information, user events and any user event properties that may influence the GUI dependent rendering by the client adapters 232, 242 in addition to user event properties that may influence application logic events. The GUI independent object 260 is generated and sent from the interpretive runtime engine 212 to a the client adapters 232, 242, which is subsequently rendered in a client user interface via the respective client presentation logic 238, 248.

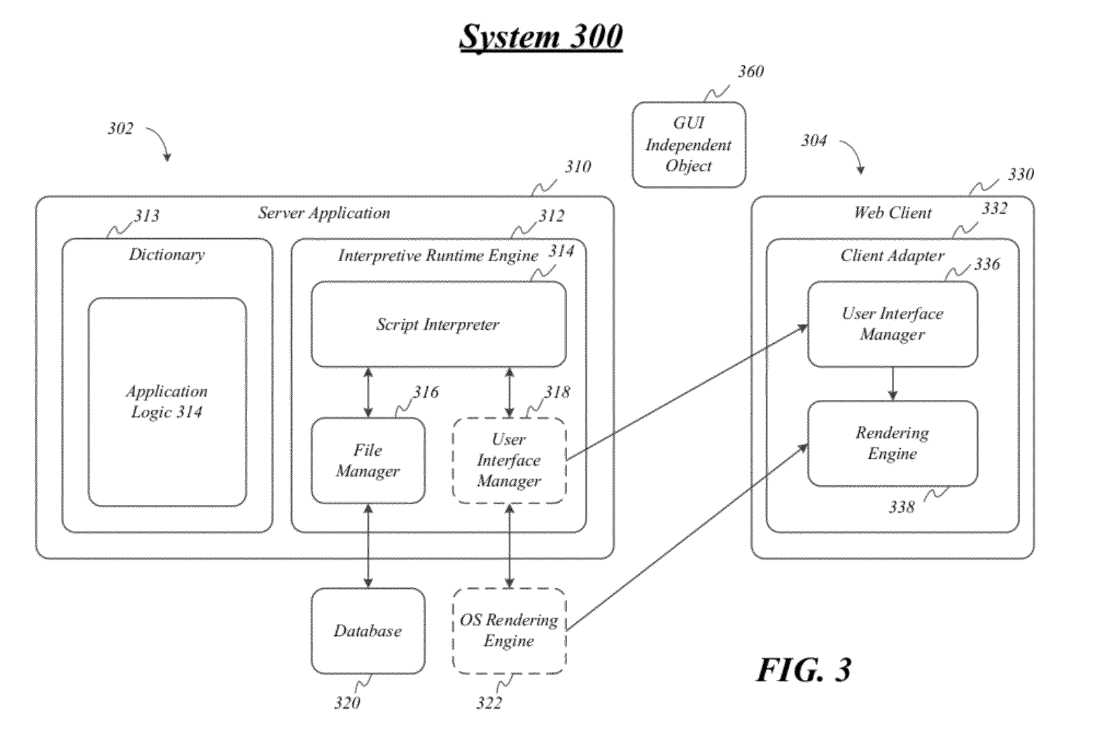

FIG. 3 illustrates a specific implementation of a n-tier client-server system 300. The client-server system 300 may comprise a server 302 and a client 304. The server 302 may be representative of, for example, the server 202 described with reference to FIG. 2. The client 304 may be representative of, for example, one or both of the clients 204, 206 described with reference to FIG. 2.

In the illustrated embodiment shown in the client-server system 300, the server 302 may implement a server application 310. In one embodiment, for example, the server application 310 may be coded using a Microsoft Dexterity® programming language, among other suitable types of programming languages. When implemented as a Microsoft Dexterity application, the server application 310 may be generally divided into two distinct elements. The first element is an interpretive runtime engine 312 that addresses the technology aspects of the application environment such as communicating with an operating system (OS) and establishing and managing a connection to the database 320 via a file manager 316. The second element is an application dictionary 313 that hosts the application logic 315, such as the application rules, business rules, forms, reports, resources, metadata, and the application code that enables responses to user commands and input. Examples of application code may include sanScript code, a Microsoft Visual Studio® addin, Microsoft Visual Basic® Application (VBA), Microsoft Dexterity Continuum, and so forth. This architecture isolates the application logic 315 from UI style changes and platform advances, such as upgrades to a platform OS, for example.

The sanScript code is used to control how an application operates. The sanScript code is typically written in small segments, or scripts, that are attached to objects in the application dictionary 313, such as fields, menus, screens and forms. Scripts are run as the user interacts with that particular object in the application. For example, a script applied to a push button will run when the user clicks the button.

As shown, the client 304 may comprise a web client 330. The web client 330 may be representative of, for example, one or both of the web clients 230, 240. The web client 330 may deliver a set of components and services oriented toward the user interface and user interaction, including user input and lightweight user interface controls for use with the server application 310. To achieve a smooth migration to a 3-tier architecture, however, numerous technology challenges posed by the introduction of the web client architecture need to be overcome to enable an efficient web client interface.

A goal of the embodiments described herein is to reduce modifications needed for existing code and GUI metadata. To solve some of the aforementioned challenges, various embodiments are directed toward techniques for decoupling a user interface manager 318 and an OS rendering engine 322 from the interpretive runtime engine 312. The user interface manager 318 is system software that controls the placement and appearance of various user interface elements, such as a GUI screen, within a given GUI system. The OS rendering engine 322 is system software for displaying content. The interpretive runtime engine 312 is an executed version of the server application 310.

The use of forms (or screens) is a core component of any Microsoft Dexterity application. The forms are a mechanism by which a user will interact with the server application 310. When the server application 310 is implemented as a Microsoft Dexterity application, for example, a Microsoft Dexterity screen typically includes sanScript code associated with the controls for that screen. The sanScript code executes in response to user events given the intended function of the screen and the controls (e.g., save a transaction, post a batch) under the direction of the script interpreter 314.

In non-web versions of the server application 310, the UI is administered by the user interface manager 318, which in turn communicates with the OS rendering engine 322 to display the actual Microsoft Dexterity screen on the display screen with the control elements previously laid out by a developer.

However, in order to facilitate the transition to the web client 3-tier architecture of the client-server system 300, the user interface manager 318 and the OS rendering engine 322 may be decoupled from the functions of the interpretive runtime engine 312. This allows the web client 332 to implement client versions of a user interface manager 336 and a rendering engine 338 on the client 304. This further allows the interpretive runtime engine 312, which is executing on the server 302, to produce a GUI independent object 360 for use by the web client 332. With a GUI independent object 360, a classic client can continue to serve up a typical GUI screen (e.g., a Microsoft Win32® screen), while also allowing the web client 330 of the client 304 to serve up a web-based representation of that same screen, without having to change any of the underlying application logic 315 of the server application 310.

Decoupling the user interface manager 318 and the OS rendering engine 322 from the interpretive runtime engine 312 allows for screens (forms) to move freely between non-web (e.g., desktop or Win32) environments and web environments. With the user interface manager 318 and the OS rendering engine 322 decoupled, the server application 310 can run as a service in the background, awaiting user events that may be received either via a traditional Win32 form or a web client form, and still be able to execute script events regardless of the type of form through which it was submitted.

To facilitate this decoupling, the GUI dependent and GUI independent processing layers of the server application 310 are first separated. Instead of direct communication between these two layers, rendering and event metadata are exposed using the GUI independent object 360. The GUI independent object 360 may contain any user event properties that may influence the GUI dependent rendering by the client adapter 332, in addition to user event properties that may influence application logic events. The GUI independent object 360 is then sent to a (GUI dependent) client adapter 332 which is rendered in a client user interface screen on a display for the client 304. Examples of some client adapters 332 may include, but are not necessarily limited to, Microsoft Silverlight®, HTML, Win32 GDI, .Net Forms, among others.

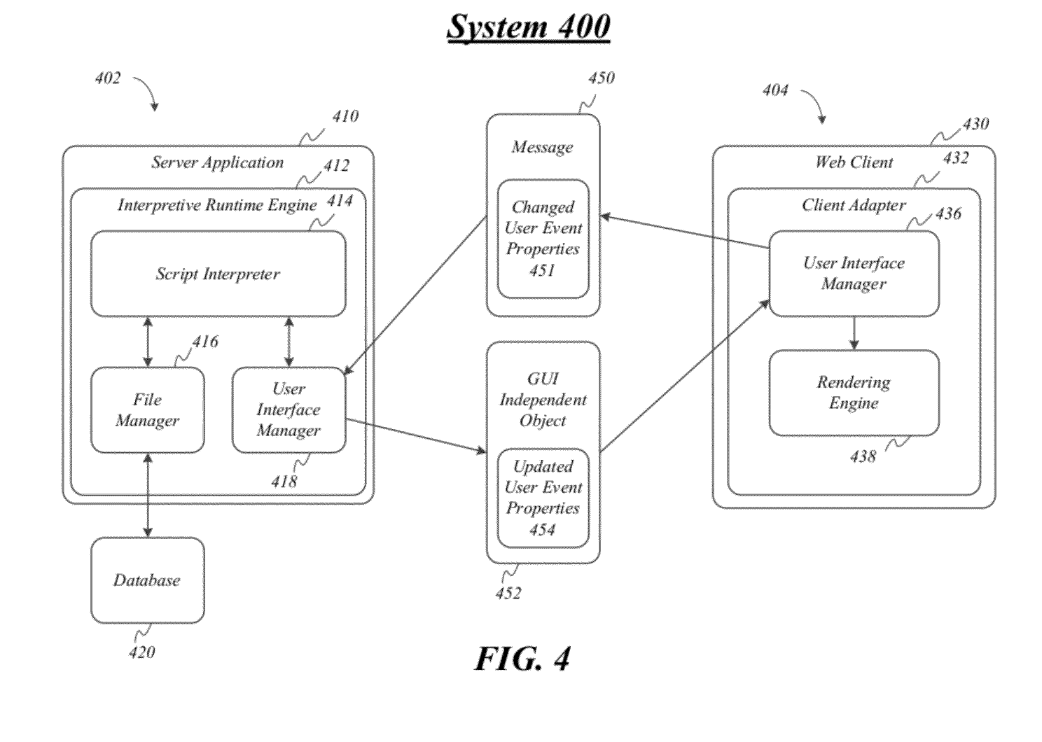

FIG. 4 illustrates a specific implementation of a n-tier client-server system 400. The client-server system 400 may comprise a server 402 and a client 404. The server 402 may be representative of, for example, the servers 202, 302 described with reference to FIGS. 2, 3. The client 404 may be representative of, for example, one or all of the clients 204, 206, 304 described with reference to FIGS. 2, 3.

On the server 402, there may be a server application 410 including an interpretive runtime engine 412 that may be responsible for executing one or more application layers or coupled with other components that run one or more application layers. The interpretive runtime engine 412 may further comprise a script interpreter 414, a file manager 416, and a user interface manager 418. The script interpreter 414 may be in communication with the file manager 416 and server user interface manager 418. The file manager 416 may also be in communication with a database 420.

On the client 404 there is a web client 430 executing a client adapter 432. The client adapter 432 may include a user interface manager 436 and a rendering engine 438 for displaying content in a client user interface, such as a client user interface, in accordance with the client presentation logic 238, 248 shown in FIG. 2.

FIG. 4 may represent a 3-tier application architecture in that certain application layers may be distributed between the server 402 and client 404. For instance, the client presentation logic 238 and/or 248 may reside on the client 404, while the application logic 214 and the database logic 216 may be distributed on the server 402, as shown in FIG. 2. The illustrated architecture of FIG. 4 has decoupled the functionality of the user interface manager 436 and rendering engine 438 from the interpretive runtime engine 412 on the server 402 and placed it with the client adapter 432 on the client 404.

In one embodiment, the interpretive runtime engine 412 may include a script interpreter 414. The script interpreter 414 may be generally arranged to execute scripted code in response to user events such as, but not limited to, saving a transaction or posting a batch. Examples of scripted code may include pre-scripts, change scripts, and post-scripts, among other types of scripts.

In one embodiment, the interpretive runtime engine 412 may include a file manager 416. The file manager 416 may be generally arranged to perform file management operations on files stored in a database 420. Examples of file management operations may include create file, open file, copy file, move file, delete file, among others.

In one embodiment, the interpretive runtime engine 412 may include a user interface manager 436. The user interface manager 436 may be generally arranged to control the placement and appearance of various user interface elements, such as screen elements, within a user interface implementing a given GUI system.

In operation, a user may interact with a client user interface via the web client 430. The web client 430 may comprise a web browser having user interface code for rendering web-based content. The web client 430 may be implemented using various web technologies, such as HTML, XHTML and XML, among others. Examples of a web client 430 may include without limitation Internet Explorer® made by Microsoft Corporation, Redmond, Wash., among other types of web browser software.

According to an embodiment, in operation a user may interact with a client user interface via a web client 430 and may enter user events that may be received and processed by the client adapter 432. Examples of user events may include without limitation moving a pointer to a field, hovering over a field, selecting a field, a mouse click on a button, filling in a text field, and similar operations. A user event may be defined using a set of user event properties. In one embodiment, only changes to user event properties need to be sent from the web client 430 to the server application 410, rather than a complete set of user event properties. This differential technique may conserve communication bandwidth and reduce latency.

A user event property may be any attribute that can be assigned to user interface elements, such as fields, screens or graphical objects, displayed in a user interface layout. The user event property describes attributes of a presentation style or presentation format for corresponding user interface elements. The user event property may include, among other types of information, a user interface element identifier (ID), a property (e.g., border, font, font size, font color, background, background color, style, right alignment, center alignment, right alignment, single space, double space, and so forth), and a property value (e.g., false, true, 0, 1, etc.). For example, a GUI screen might have an identifier “Window 001” with a Resizeable property set to False, which means that the GUI screen cannot be resized by the user at runtime. These are only a few examples, and any user interface elements and user interface properties may be implemented as desired for a given implementation. The embodiments are not limited in this context.

The web client 430 may send a set of changed user event properties 451 in a message 450 to the server application 410. The user interface manager 418 operating on the server 402 forwards the changed user event properties 451 in the message 450 to the script interpreter 414 for processing. The server application 410 may ensure that application inputs and application states are proper before executing any application logic for the server application 410. The script interpreter 414 may then communicate with the file manager 416 which has access to database 420 if needed to the execution of any application rules resulting from the changed user event properties 451 in the message 450 received from the client 404. Upon execution of the appropriate application logic, the interpretive runtime engine 412 may produce a GUI independent object 452. The GUI independent object 452 may include, among other information, updated user event properties 454. User interface manager 418 implemented by the server 402 may send the GUI independent object 452 along with any updated user event properties 454 back to the client 404. The client adapter 432 via client user interface manager 436 and rendering engine 438 may then update the previously rendered image using the GUI independent object 452 along with the updated user event properties 454 generated by and received from the server application 410.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

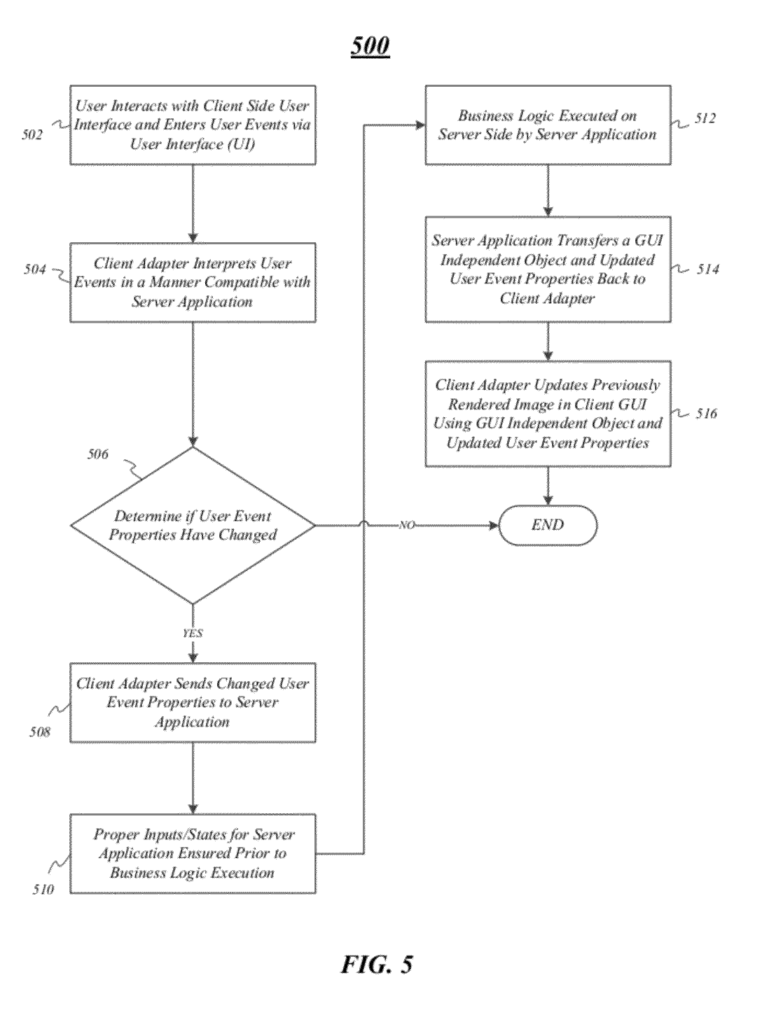

FIG. 5 illustrates an embodiment of a logic flow 500. The logic flow 500 may illustrate operations performed in accordance with one or more embodiments. For instance, the logic flow 500 may illustrate operations performed by the web client 430 and/or server application 410.

In the logic flow 500, a user interacts with a web client executing in a client side user interface at block 502. For instance, the web client 430 may receive user input in the form of one or more control directives received from an input device that affects one or more user interface elements of a user interface as presented by the rendering engine 438. The user input may interact with the user interface element causing a user event. For instance, a user may select a field on a form presented in a GUI screen, and modify a value for the field.

In the logic flow 500, a client adapter executing therein may interpret a control directive representing the user events in a manner compatible with a server application executing on the server at block 504. For instance, the client adapter 432 executed by the web client 430 may interpret user events in a similar manner as the server application 410. User events may include one or more user interactions with the user interface running on the web client 430 such as, but not limited to, clicking a button, filling in a text field, and so forth.

In the logic flow 500, the interpreting operation at block 504 examines the newly input user event properties to determine if the user event properties have changed at diamond 506 to an extent needed that the server application should be notified. For instance, the client adapter 432 may examine any user inputs and corresponding changes to properties of affected user interface elements to determine if the user event properties have changed above some threshold amount. For instance, hovering above a field to bring it in focus might be insufficient to trigger any changes in user event properties, while selecting a field would be sufficient to notify the server application 410.

In the logic flow 500, in those cases where notification is required, the client adapter may send any pending changed user event properties to the server application at block 508. For instance, the client adapter 432 may send changed user event properties 451 in the message 450 to the server application 410 via the network 250. In some embodiments, the client adapter 432 may send multiple sets of changed user event properties 451 for multiple user events in the message 450 to the server application 410 executing on the server 402. This “batch” sending can be useful in many ways, including assisting the server application 410 in user event timing. For instance, the script interpreter 414 may time execution of various scripts (e.g., pre-scripts, change scripts, post-scripts, etc.) to ensure an accurate sequence of updates to the server application 410. The batch sending can also reduce communication overhead by sending fewer messages 450 across the network 250. Other advantages exist as well, and the embodiments are not limited in this context.

In the logic flow 500, a runtime engine executing on the server may ensure proper inputs/states for the server application at block 510 before business logic events may be executed at block 512. For instance, the interpretive runtime engine 412 executing on the server 402 may ensure proper application inputs and application states for the server application 410 before executing any application or business logic.

In the logic flow 500, updated user event properties resulting from the execution of the business logic along with a GUI independent object may be transferred back to the client adapter at block 514. For instance, updated user event properties 454 resulting from the execution of the application or business logic along with the GUI independent object 452 may be sent from the server application 410 to the web client 430 for transfer back to the client adapter 432.

In the logic flow 500, the client adapter may then update the previously rendered image in the client user interface at block 516 using the updated user event properties and GUI independent object. For instance, the client adapter 432 receive the GUI independent object 452, and the rendering engine 438 may update the previously rendered image in the client user interface using the updated user event properties 454 and the GUI independent object 452.

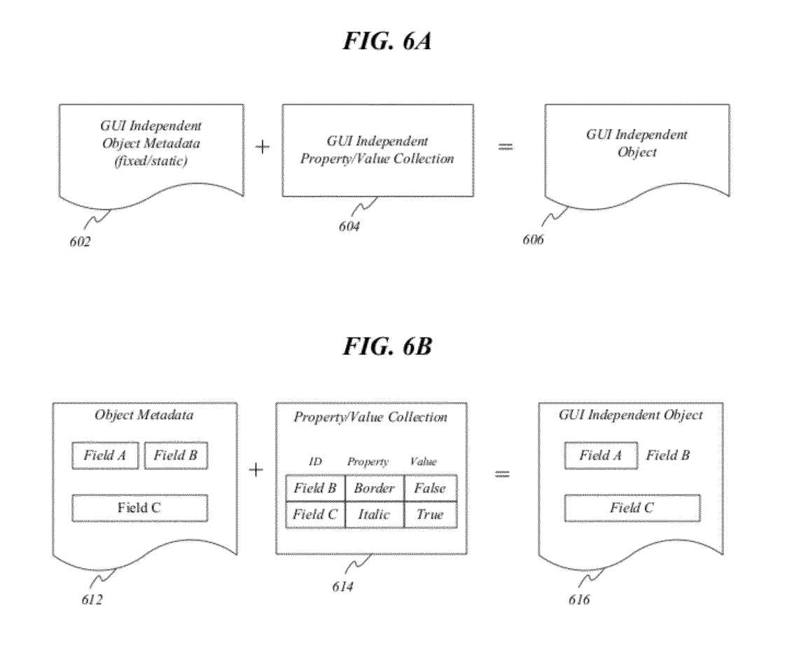

FIG. 6A illustrates an embodiment of how a GUI independent object 452 may be created for a client adapter 432 using data from the server application 410. As previously described, the client adapter 432 may receive a GUI independent object 452 having updated user event properties 454. The updated user event properties 454 may comprise, among other information, GUI independent object metadata 602. In one embodiment, the GUI independent object metadata 602 may comprise fixed or static metadata. The updated user event properties 454 may further comprise a property/value collection 604. The fixed/static GUI independent object metadata 602 may be combined with the GUI independent property/value collection 604 to yield a GUI independent object 606 that can be rendered in the web client 430 by the client adapter 432.

FIG. 6B illustrates an embodiment of how a specific GUI independent object 452 may be created using the constructs set out in FIG. 6A. The updated user event properties 454 may comprise, among other information, object metadata 612 and a property/value collection 614.

The updated user event properties 454 may comprise object metadata 612 having one or more user interface elements. In this example, the object metadata 612 includes three user interface elements in the form of fields, labeled Field A, Field B and Field C. Each of Fields A, B, and C are shown generically as a text box with a border around default font text comprised of the phrases ‘Field A’, ‘Field B’, and ‘Field C’ respectively.

The updated user event properties 454 may further comprise a property/value collection 614. In one embodiment, the property/value collection 614 may be implemented in a data structure, such as a table having one or more tuples (or rows), with each tuple comprising attributes (or columns) including an identifier for a user interface element, a property for the user interface element, and a value for the property. The table of identifiers, properties and values may correspond to the fields of the object metadata 612.

When combined together the result may be a GUI independent object 616. As shown in the GUI independent object 616, Field A is unchanged from the generic metadata version because none of its properties or values was changed in the property/value collection 614. Field B is shown without its border because the property ‘border’ was set to the value ‘False’ in the property/value collection 614. The text in Field C is shown in italics because the property ‘italic’ was set to the value ‘True’ in the property/value collection 614. The object 616 can now be rendered on the client 404 in the web client 430 by the rendering engine 438 of the client adapter 432.

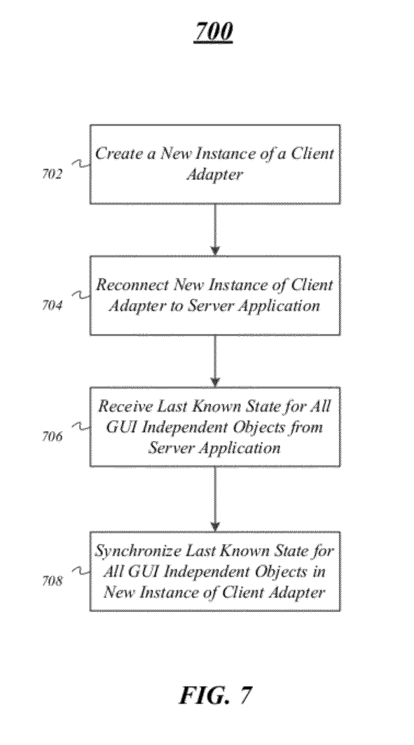

FIG. 7 illustrates an embodiment of a logic flow 700. The logic flow 700 may illustrate operations performed in accordance with one or more embodiments. For instance, the logic flow 700 may illustrate operations performed by the web client 430 and/or the server application 410 for purposes of recovering a client adapter 432 that has been destroyed.

Another benefit of the embodiments described herein is that a rendered image in a given client 404 may be recovered if a client adapter 432 is destroyed. If a client adapter 432 is destroyed, the rendered image comprised of various GUI dependent objects 452 is also destroyed. However, the server application 410 may continue to hold state in the form of the GUI independent objects 452. As shown in FIG. 7, a user may interact with the web client 430 executing in a client side user interface to create a new instance of a client adapter 432 at block 702. The new instance of the client adapter 432 may then reconnect to the server application 410 at block 704. Upon reconnection, the server application 410 may still maintain the last known state for all GUI independent objects 452. At block 706 the last known state for all GUI independent objects 452 is transferred back to, and received by, the client 404. The last known state for all GUI independent objects 452 may then be synchronized with the web client 430 of the client 404 at block 708. The result is that a current state for the client adapter 432 may be effectively recovered using information stored by the server application 410.

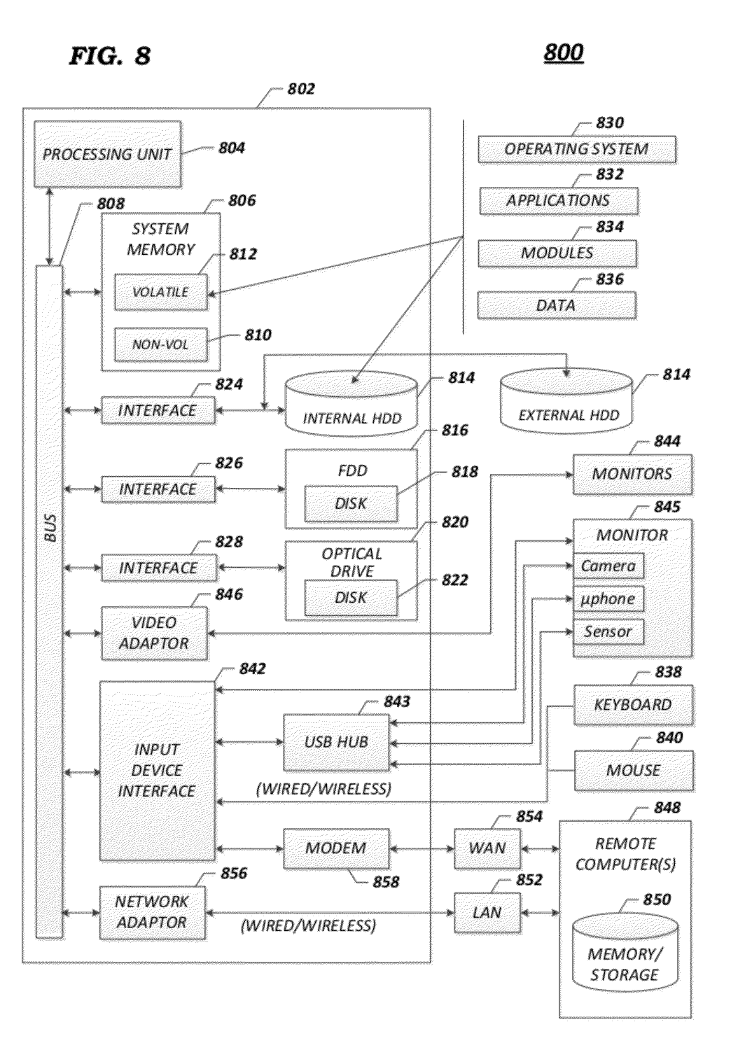

FIG. 8 illustrates an embodiment of an exemplary computing architecture 800 suitable for implementing various embodiments as previously described. The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The system memory 806 may include various types of memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836. The one or more application programs 832, other program modules 834, and program data 836 can include, for example, software components for the client-server systems 200, 300 and 400.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

One or more monitors 844 or other type of display devices are also connected to the system bus 808 via an interface, such as a video adaptor 846. In addition to the monitor 844, a computer typically includes other peripheral output devices, such as speakers, printers, and so forth. One or more monitors 845 may also be connected to the system bus 808 via an input device interface 842 and/or a hub, such as USB hub 843. The monitors 845 may comprise various components, such as a video camera, array microphone, touch sensors, motion sensors, speakers, and so forth. The components may be connected to the input device interface 842 via the USB hub 843.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

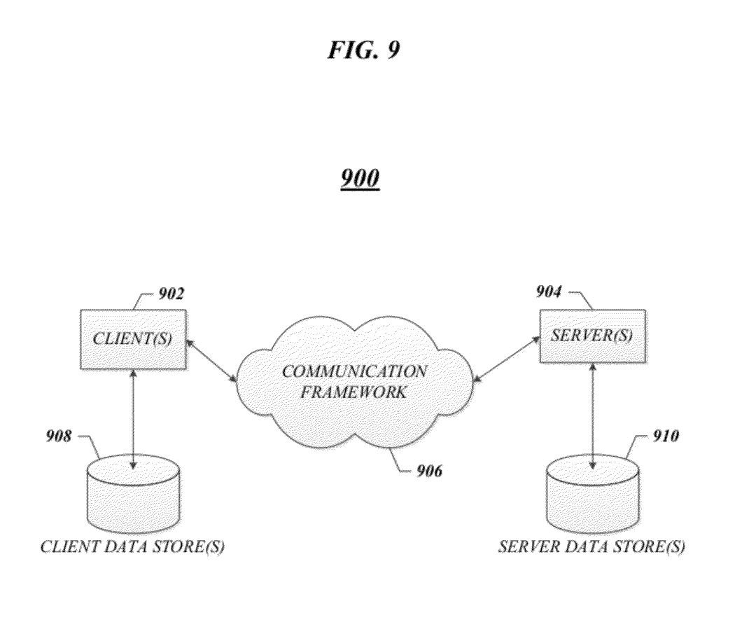

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the web client 35. The servers 904 may implement the runtime engine 30. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 902 and the servers 904 may include various types of standard communication elements designed to be interoperable with the communications framework 906, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 902 and a server 904 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, logic devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a computer-readable storage medium arranged to store logic. Examples of a computer-readable storage media include any storage medium capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method, comprising:
receiving a control directive representing a user event in a client user interface;
determining whether user event properties associated with the user event are changed;
sending changed user event properties to a server application executing on a server;
receiving a graphical user interface (GUI) independent object having updated user event properties from the server application; and
updating a rendered image in the client user interface based on the GUI independent object and updated user event properties received from the server application.

2. The computer-implemented method of claim 1, comprising receiving the GUI independent object having updated user event properties, the updated user event properties comprising object metadata having one or more user interface elements.

3. The computer-implemented method of claim 1, comprising receiving the GUI independent object having updated user event properties, the updated user event properties comprising a property/value collection having one or more tuples, with each tuple comprising an identifier for a user interface element, a property for the user interface element, and a value for the property.

4. The computer-implemented method of claim 1, comprising sending multiple changed user event properties for multiple user events in the message to the server application executing on the server.

5. The computer-implemented method of claim 1, comprising updating one or more user interface elements of the rendered image in the client user interface based on the GUI independent object and updated user event properties received from the server application.

6. The computer-implemented method of claim 1, comprising updating a rendered image in the client user interface based on the GUI independent object and updated user event properties received from the server application by a rendering engine executing on the client.

7. The computer-implemented method of claim 1 comprising:
creating a new instance of a client adapter when a previous instance of a client adapter and its associated rendered image comprised of GUI dependent objects have been destroyed;
reconnecting the new instance of the client adapter to the server application;
receiving a last known state for all GUI independent objects from the server application; and
synchronizing in the new instance of the client adapter the last known state for all GUI independent objects received from the server application.

8. An article of manufacture comprising a storage medium containing instructions that when executed enable a system to:
receive a user event in a client user interface;
determine user event properties associated with the user event have changed;
send changed user event properties to a server application;
receive a graphical user interface (GUI) independent object from the server application; and
render an image in the user interface based on the GUI independent object and updated user event properties of the independent GUI object.

9. The article of manufacture of claim 8, further comprising instructions that when executed enable a system to send multiple changed user event properties for multiple user events in the message to the server application.

10. The article of manufacture of claim 8, further comprising instructions that when executed enable a system to update one or more user interface elements of the rendered image in the client user interface based on the independent user interface object and updated user event properties received from the server application.

11. The article of manufacture of claim 8, further comprising instructions that when executed enable a system to create a new instance of a client adapter when a previous instance of a client adapter and its associated rendered image comprised of GUI dependent objects have been destroyed.

12. The article of manufacture of claim 11, further comprising instructions that when executed enable a system to reconnect the new instance of the client adapter to the server application.

13. The article of manufacture of claim 12, further comprising instructions that when executed enable a system to receive a last known state for all GUI independent objects from the server application.

14. The article of manufacture of claim 13, further comprising instructions that when executed enable a system to synchronize in the new instance of the client adapter the last known state for all GUI independent objects received from the server application.

15. An apparatus, comprising:
a logic device; and
a web client operable on the logic device, the web client comprising a client adapter operative to detect a user event for a client user interface, send changes to user event properties associated with the user event to a server application, receive a graphical user interface (GUI) independent object and updated user event properties from the server application, and update a rendered image in the client user interface using the GUI independent object and updated user event properties received from the server application.

16. The apparatus of claim 15, the GUI independent object having updated user event properties, the updated user event properties comprising object metadata and a property/value collection, the object metadata comprising one or more user interface elements, and the property/value collection comprising one or more tuples each comprising an identifier for a user interface element, a property for the user interface element, and a value for the property.

17. The apparatus of claim 15, the client adapter comprising a user interface manager to control the client user interface.

18. The apparatus of claim 15, the client adapter comprising a rendering engine to update the rendered image.

19. The apparatus of claim 15, the web client operative to create a new instance of the client adapter when a previous instance of the client adapter and its associated rendered image comprised of one or more GUI dependent objects have been destroyed.

20. The apparatus of claim 19, the new instance of the client adapter operative to reconnect to the server application, receive a last known state for all GUI independent objects from the server application, and synchronizes in the new instance of the client adapter the last known state for all GUI independent objects received from the server application.
